(19) United States
(12) Patent Application Publication
(10) Pub. No.: US 2006/0058016 A1
(43) Pub. Date: Mar. 16, 2006

(54) Wireless projector equipped with embedded download server

(76) Inventors: Chien-Wu Yen, Miao-Li County (TW); Tung-Lung Lai, Miao-Li County (TW); Tzu-Hai Chung, Miao-Li County (TW)

Correspondence Address: BIRCH STEWART KOLASCH & BIRCH, PO BOX 747, FALLS CHURCH, VA, 22040-0747, US

(21) Appl. No.: 10/939,393

(22) Filed: Sep. 14, 2004

(51) Int. Cl. H04M 3/00

(52) U.S. Cl. 455/419

(57) ABSTRACT

A wireless projector equipped with an embedded download server to allow users to directly download transport software and driver from a server to a client device to improve use convenience. Through the embedded download server and the technique of Universal Plug and Play (UPnP), the client device can directly download the driver from the embedded download server through a wire or wireless communication mode, and directly download the transport software between the client device and the projector to eliminate the inconvenience of pre-installing the transport software and the driver before using the wireless projector. In addition, administrators can directly update the firmware and software of the projector to improve management.

### FIELD OF THE INVENTION

The present invention relates to a wireless projector and particularly to a projector equipped with embedded download server.

### BACKGROUND OF THE INVENTION

Projectors are quite popular these days, and have gradually shown up in people's life. With the technology of wireless local area network (wireless LAN) well developed, many wireless projectors have been developed and introduced on the market. These days when users do presentation, they do not have to connect the client device (such as a notebook computer or PDA) to the projector with an image transport line. Instead, through a wireless network, image signals output from the client device can be directly transmitted to the projector. Not only the wiring problem of the image transport line may be eliminated, one set of notebook computer can simultaneously transmit signals to a plurality of projectors to do presentation concurrently.

However, for linking the wireless projector, the client device has to install transport software and wireless projector driver, and the wireless LAN has to link the wireless communication module of the wireless projector to transmit the image signals to the wireless projector. As every wireless projector vendor has its own communication technology and software, for users who have to go to different locations, to setup matching transport software and driver for each wireless projector in advance is a troublesome task. Moreover, the driver is generally stored in an optical disk, but many optical disk drives of the present notebook computers are connected externally. If users forget to prepare the optical disk drive, the driver cannot be installed, and the wireless projector becomes useless. If a PDA is used, the software cannot be installed through the optical disk. Then the wireless connecting function is useless.

### SUMMARY OF THE INVENTION

The primary object of the present invention is to provide a wireless projector that allows a client device to instantly download transport software and driver without pre-installation to realize wireless transport operation.

To achieve the foregoing object, the invention has an embedded server built in the wireless projector. The server contains pre-loaded transport software and driver. The embedded server supports Universal Plug and Play (UPnP) function and has a built-in wireless communication module that conforms to a standard wireless transport protocol to perform wireless communication with the client device that also equips with a wireless communication module so that the client device can instantly download the transport software and driver of the wireless projector. Hence any client device that equips with the wireless communication module can directly download the transport software and driver resided in the wireless projector through a wireless communication approach without pre-installation to accomplish wireless communication with the wireless projector.

Another object of the invention is to provide a wireless projector to facilitate software updating. Administrators can perform software update or upgrade for the wireless projector by uploading the software through the wireless communication approach to improve operation convenience.

To achieve the object set forth above, the wireless projector equipped with embedded download server of the invention has a rewritable memory unit. Thus the administrators can update or upgrade the software of the projector.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a system functional block diagram of an embodiment of the present invention.

FIG. 2 is a schematic view of a client device (such as a PC, PDA, Notebook PC) linking to the present invention.

FIG. 3 is a schematic view of the procedures for linking a client device to the present invention.

FIG. 4 is a system functional block diagram of another embodiment of the present invention adopted UPnP technique.

FIG. 5 is a system functional block diagram of yet another embodiment of the present invention equipped with a memory card access interface.

### DETAILED DESCRIPTION OF THE PREFERRED EMBODIMENTS

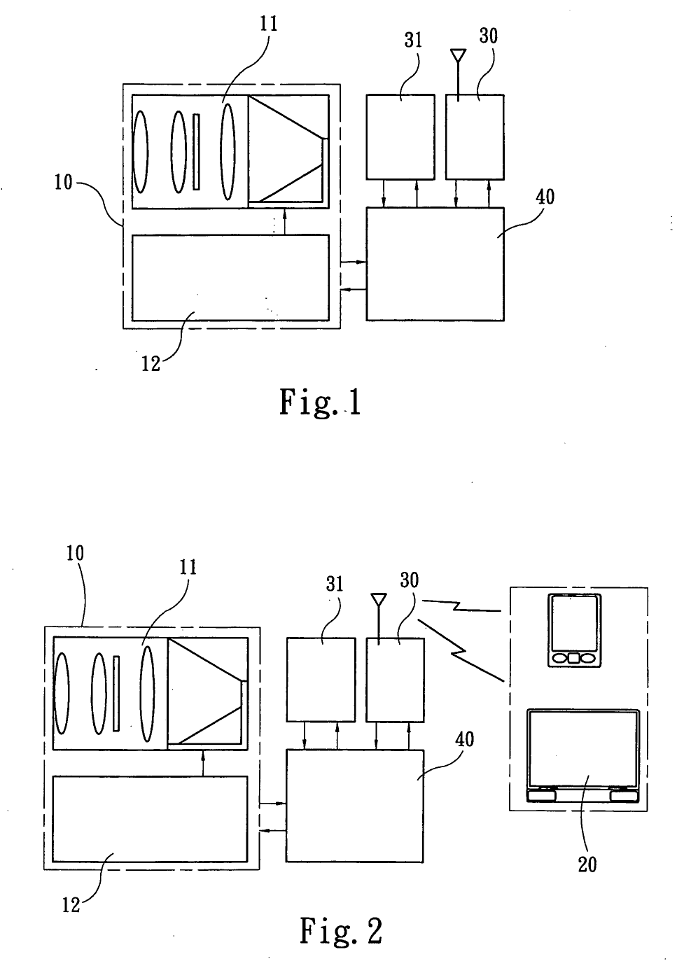

Please refer to FIG. 1 for the system functional block diagram of an embodiment of the present invention. It includes:
a projection module 10 which equips basic function elements of a projector such as an optical engine 11 and a related image signal processing circuit 12. The image signal processing circuit 12 can project image signals generated by a client device 20 (such as PC, PDA, notebook PC) to a projection surface through the optical engine 11 (referring to FIG. 2);
a server communication module 30 which is a wireless communication module according to the embodiment of the invention to receive the image signals generated by the client device 20 through a wireless communication approach and transmit to the image processing circuit 12. In another embodiment, the communication module further includes a wire communication unit 31. Both the wire communication unit 31 and the wireless communication module adopt a common standard network protocol such as Internet protocol (IP), transmission control protocol (TCP), user datagram protocol (UDP), hypertext transmission protocol (HTTP), and the like to communicate with the client device 20; and
an embedded download server 40 which contains preloaded transport software and driver for controlling the wireless projector. The client device 20 establishes communication path with the embedded download server 40 through the server communication module 30 to instantly download the transport software and driver of the wireless projector.

Take wireless LAN IEEE 802.11b specification for example. It defines two types of wireless network operation modes, namely, Ad hoc mode and infrastructure mode. In the Ad hoc mode (also called point to point mode), the clients can directly communicate with each other (without using wireless access point). In the infrastructure mode, different client devices have to communicate with each other through a wireless access point. According to this specification, when the wireless communication module of a client device 20 (such as a notebook PC or PDA) is activated, it scans (searches) the wireless frequencies where it is located to find the wireless access point and other wireless clients under the Ad hoc mode. If the wireless clients are preset in the infrastructure mode, the wireless communication module will select a linking wireless access point. This process is generally accomplished through a wireless adapter contained in the wireless communication module. Such a selection is automatically accomplished through a Service Set Identifier (SSID) and signal power and detected error information. Then the wireless communication module switches to a designated channel of the selected wireless access point to coordinate use of ports. The process set forth above is called establishing link.

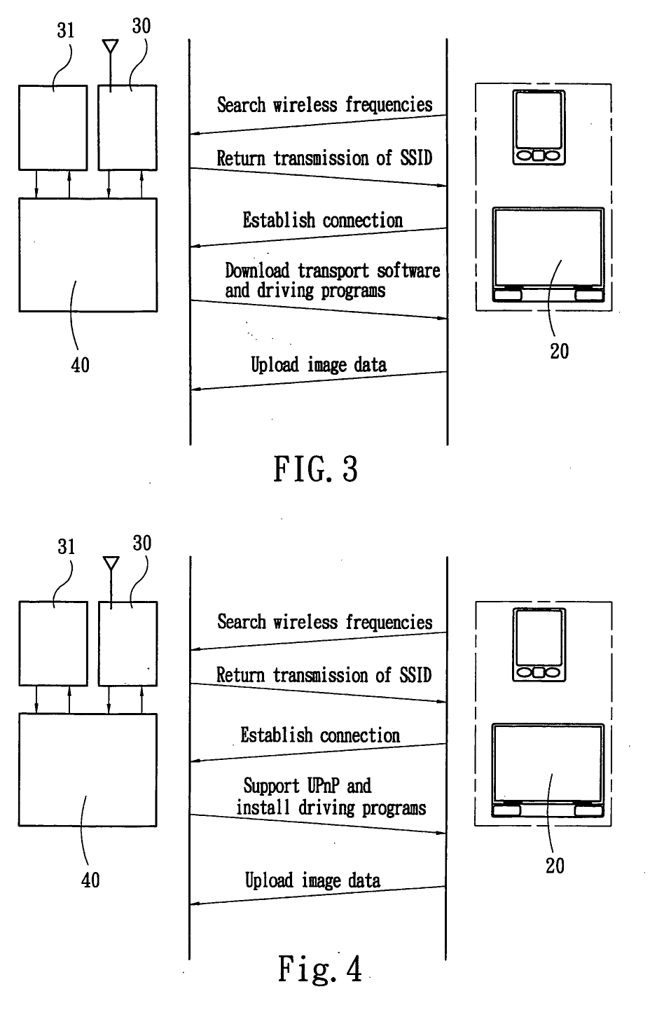

Refer to FIG. 3 for an embodiment of the invention. The wireless communication module 30 of the server previously discussed plays the role of a wireless access point or another wireless client. After the wireless communication module of the client device 20 is activated, it starts scanning (searching) the wireless frequencies in the area where it is located. Once the communication module 30 of the server is detected, a wireless link is established. The client device 20 can download the required transport software and driver from the embedded download server 40 through the standard communication protocol. Then the image data to be projected are transported to the server communication module 30 through the transport software, and processed by the image signal processing circuit 12 and transferred to the optical engine 11 of the projection module 10 for projecting to the projection surface.

Refer to FIG. 4 for another embodiment of the invention. The embedded download server 40 further supports UPnP technique. Once the client device 20 has established connection with the embedded download server 40 through the communication module 30 of the server to form a point-to-point link, the transport software and driver may be downloaded. Using the existing network protocol such as IP, TCP, UDP, HTTP, and the like forms the UPnP. It is an architecture that enables any type of intelligent appliance, wireless device and personal computer to achieve point-to-point network connection. It is also an open and distributed network architecture that employs the existing network technologies (such as TCP/UDP/IP) to enable network-linking devices in the houses, companies or other public networks to transmit data or control information. UPnP extends the original plug and play concept, and allows each device to be dynamically added to or removed from the network without user to do installation or alteration. It also has automatic search function.

According to the embodiments of the invention, the server communication module 30 is not limited to be used only in the wireless LAN. Any other wireless communication techniques that can achieve the communication object may be used, such as Blue tooth communication technique, infrared communication technique (IrDA), and the like. Similarly, the wire communication module mentioned above may be realized through a transmitter adapter such as an interface conforming to specifications of USB or IEEE 1384 or the like to provide connection ports for the client device.

Hence any client device that has a wireless communication module can directly download the transport software and driver resided in the wireless projector through the wireless communication approach and install without pre-installing them, thereby to achieve wireless communication with the wireless projector. To provide file transport server of different transport protocols, the embedded download server may be a HTTP server, FTP server or TFTP server.

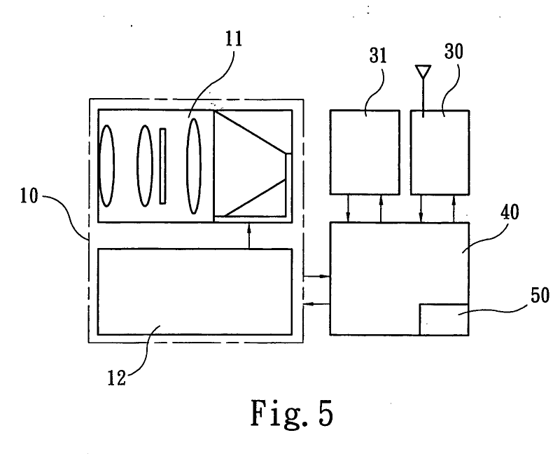

Refer to FIG. 5 for yet another embodiment of the invention that includes a memory card access interface 50. The memory card access interface may support various specifications of erasable flash memory cards such as Compact Flash (CF), MultiMediaCard (MMC), Smart Media (SM), Secure Digital (SD), Memory Stick (MS), MS pro, MS Duo, XD and Micro Drive. Through these flash memory card access interfaces, users can easily share or exchange data or images stored therein with the embedded download server 40.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A wireless projector equipped with embedded download server allowing users to directly download transport software and driver from a server to a client device, comprising:
a projection module for projecting image signals from the client device to a projection surface;
a server communication module being a wireless communication module for receiving the image signals from the client device through a wireless communication means and transmitting the image signals to the projection module, the wireless communication module communicating with the client device according to a common standard network protocol; and
an embedded download server having pre-loaded the transport software and the driver that control the wireless projector to allow the client device to establish a communication path with the embedded download server through the server communication module to instantly download the transport software and the driver of the wireless projector.

2. The wireless projector of claim 1, wherein the projection module includes an optical engine and an image signal processing circuit processing the image signals generated by the client device, the image signals being projected to the projection surface through the optical engine.

3. The wireless projector of claim 1, wherein the server communication module includes a wire communication module communicating with the client device according to a common standard network protocol.

4. The wireless projector of claim 1, wherein the server communication module conforms to a network communication protocol selected from the group consisting of Internet protocol (IP), transmission control protocol (TCP), user datagram protocol (UDP) and hypertext transmission protocol (HTTP).

5. The wireless projector of claim 3, wherein the server communication module conforms to a network communication protocol selected from the group consisting of Internet protocol (IP), transmission control protocol (TCP), user datagram protocol (UDP) and hypertext transmission protocol (HTTP).

6. The wireless projector of claim 1, wherein the server communication module adopts a wireless local area network, WLAN.

7. The wireless projector of claim 1, wherein the server communication module adopts a blue tooth communication technique.

8. The wireless projector of claim 1, wherein the server communication module adopts an infrared communication technique (IrDA).

9. The wireless projector of claim 3, wherein the wire communication module is a USB interface.

10. The wireless projector of claim 3, wherein the wire communication module is an IEEE 1394 interface.

11. The wireless projector of claim 1, wherein the embedded download server supports the Universal Plug and Play (UPnP) technique.

12. The wireless projector of claim 1, wherein the embedded download server is a FTP server.

13. The wireless projector of claim 1, wherein the embedded download server is a TFTP server.

14. The wireless projector of claim 1, wherein the embedded download server further includes a memory card access interface.

15. The wireless projector of claim 14, wherein the memory card access interface supports erasable flash memory cards of different specifications including Compact Flash (CF), MultiMediaCard (MMC), Smart Media (SM), Secure Digital (SD), Memory Stick (MS), MS pro, MS Duo, XD and Micro Drive.
